(19) United States
(12) Patent Application Publication
(10) Pub. No.: US 2018/0009276 A1
(43) Pub. Date: Jan. 11, 2018

(54) Pneumatic Vehicle Tire with Run-Flat Properties

(71) Applicant: Continental Reifen Deutschland GmbH, Hannover (DE)

(72) Inventors: Stefan Habicht, Hannover (DE); Sascha Funk-Friedek, Hannover (DE)

(73) Assignee: Continental Reifen Deutschland GmbH, Hannover (DE)

(21) Appl. No.: 15/548,142

(22) PCT Filed: Feb. 2, 2016
(86) PCT No.: PCT/EP2016/052108

§ 371 Date: Aug. 2, 2017

(30) Foreign Application Priority Data
May 18, 2015 (DE) 10 2015 209 061.2

(51) Int. Cl. B60C 17/00; B60C 5/14

(52) U.S. Cl. CPC B60C 17/0009; B60C 5/142

(57) ABSTRACT

A pneumatic vehicle tire with run-flat properties, having a tread (1), having a multi-ply belt assembly (2), having an inner ply (4) which is of air-tight form, having a carcass (3) which, in the bead region (5), is led from axially inside axially outward as a carcass turn-up (3a) around tension-resistant cores (6), and having side walls (8) within which there is arranged at least one reinforcement profile (9) which is of sickle-shaped cross section and which is of closed ring-shaped form around the circumference of the side wall, wherein the inner ply (4) does not run continuously through the tire cross section from bead region (5) to bead region (5), it rather being the case that, within the cross-sectional height (10) of the reinforcement profile (9), the inner ply is omitted; the inner ply (4a) is, in a region situated opposite the tread (1), arranged between the two upper ends (11) of the reinforcement profiles (9), and the inner ply (4a) does not cover said two ends (11) of the reinforcement profiles (9) axially at the inside.

The invention relates to a pneumatic vehicle tire with run-flat properties, having a tread, a multi-ply breaker belt assembly, an inner layer of an airtight form, a carcass, which in the bead region is led from axially the inside axially outward around tension-resistant cores as a carcass turn-up, and sidewalls, within which there is arranged at least one reinforcing profile, which is of a sickle-shaped cross section and is of a continuous ring-shaped form over the circumference of the sidewall, the inner layer not running right through the cross section of the tire from bead region to bead region, but it rather being the case that the inner layer is omitted within the cross-sectional height of the reinforcing profile.

Such a pneumatic vehicle tire with run-flat properties is known from DE 10 2007 012 401 A1. The inner layer is omitted within the cross-sectional height of the reinforcing profile. The resultant saving of material has the effect of saving costs and weight, because less butyl rubber is used in the tire for the inner layer not arranged continuously in the tire cavity. The tire is nevertheless airtight. The inner-layer strip running around in a ring-shaped manner over the circumference and arranged under the tread overlaps the upper ends of the two reinforcing profiles axially on the inside (therefore on the inside lies on the upper two ends).

Pneumatic vehicle tires that are self-supporting when they become flat from a puncture are sufficiently well known in various embodiments. The reinforcing profiles introduced in the region of the sidewalls of the tire are formed with respect to their cross-sectional shape and their elastomer compounds in such a way that they are capable of keeping the tire supporting itself when there is a loss of the pressurized air in the event of a puncture, so that they can continue running for a certain distance. This run-flat tire construction is known as an SSR tire (Self-Supporting RunFlat Tire).

However, in particular when the run-flat tire of the prior art is in the emergency run-flat operating mode, the inner layer can become detached, starting from its exposed ends, whereby the tire can develop an air leak.

The object of the present invention is to provide a run-flat tire that has a low weight in normal running operation, is inexpensive to produce and is also airtight throughout its lifetime.

The object is achieved by the inner layer in a region lying opposite the tread being arranged between the upper ends of the two reinforcing profiles and by the inner layer not covering these two ends of the reinforcing profiles axially on the inside.

According to the invention, the inner-layer strip lying opposite the tread does not cover the reinforcing profiles axially on the inside. There are accordingly no exposed inner layer edges on the reinforcing profile. There is therefore no risk of these inner layer edges becoming detached during the normal running of the tire. The pneumatic tire with run-flat properties is airtight throughout its lifetime. Moreover, as likewise known in the closest prior art, the tire has a low weight and is inexpensive to produce.

The “upper end of the reinforcing profile” means the end of the reinforcing profile that is facing the tread. The “lower end of the reinforcing profile” means the end of the reinforcing profile that is facing away from the tread.

It is expedient if the inner layer is arranged between the two upper ends of the reinforcing profiles and if the inner layer ends in abutment with these two upper ends of the reinforcing profiles. Inner layer material is saved, with the result that the pneumatic tire can be obtained even more inexpensively.

In another embodiment of the invention, the inner layer is arranged between the two upper ends of the reinforcing profiles and the inner layer is led axially outward along the ends facing the tread, the inner layer covering these upper ends contour-parallel between 5 mm and 15 mm. The edges of the inner layer are clamped between the reinforcing profile and the carcass and are not exposed, as a result of which the edges of the inner layer are arranged particularly durably and secured against becoming detached during normal running operation.

It is advantageous for ensuring the airtightness if in the bead region there is arranged a further inner-layer strip that runs around the circumference of the tire in a circular ring-shaped manner, the inner-layer strip being arranged at the height of the bead core and covering the lower end of the reinforcing profile axially on the inside or axially on the outside contour-parallel between 5 mm and 15 mm.

It is advantageous in this respect if a rubber strip which consists of a rubber compound that does not comprise any butyl rubber compounds is arranged in the region without an inner layer between the inner-layer strips. The rubber strip is consequently arranged axially on the inside with respect to the reinforcing profile.

It is expedient if the carcass is of a single-ply form and if the reinforcing profile is arranged axially on the inside with respect to the carcass. As a result, a tire construction that is of a lower weight but stable is obtained.

However, a wide variety of carcass constructions are possible, such as for example a two-ply carcass construction, a so-called C-ply construction or a so-called angled carcass with reinforcing elements, which form an angle of 90°+/−18° with the circumferential direction.

Further features, advantages and details of the invention are explained in greater detail with reference to the single drawing, which schematically illustrates a schematic exemplary embodiment.

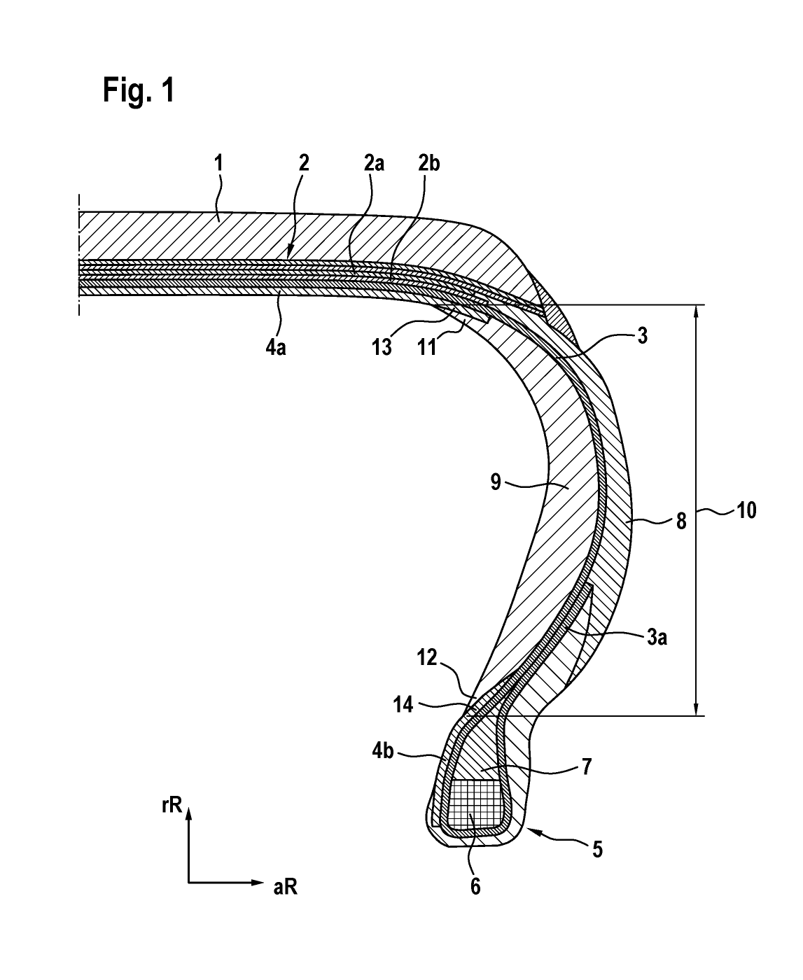

FIG. 1 shows a half cross section through a pneumatic radial tire for passenger cars with run-flat properties as a result of reinforced sidewalls. The main constituent parts of which the illustrated radial tire is made up are: a tread 1, a breaker belt 2 consisting in the embodiment shown of two plies 2a, 2b, a carcass 3 of a single-ply form, a multi-part inner layer 4a, 4b of an airtight form, beads 5 with bead cores 6 and bead fillers 7, and also sidewalls 8 and approximately sickle-shaped reinforcing profiles 9, produced from elastomeric material, in particular from a rubber compound. The reinforcing profiles are arranged axially on the inside with respect to the carcass 3. The two plies 2a, 2b of the breaker belt 2 consist of reinforcing elements of steel cord that are embedded in a rubber compound and run parallel to one another within each ply, the steel cords of the one ply 2a being oriented in a crossing arrangement in relation to the steel cords of the second ply 2b and respectively forming an angle of between 20° and 38° with the circumferential direction of the tire. The carcass 3 may also be formed in a conventional and known way, and consequently have reinforcing yarns of a textile material that are embedded in a rubber compound and run in the radial direction. The carcass 3 is led around the bead cores 6 from axially the inside axially outward; its turn-ups 3a run alongside the bead fillers 7 in the direction of the breaker belt 2. The thickness of the reinforcing profile 9 decreases both in the direction of the breaker belt 2 and in the direction of the bead 5. In the direction of the breaker belt 2, the reinforcing profile 9 reaches to below the peripheral regions of the same. In the direction of the bead 5, the reinforcing profile 9 ends at a height that lies in a region from the bead filler 7 to the bead core 6. Over most of the length of the sidewall, the reinforcing profile 9 is formed as virtually constantly thick; its thickness is 4 to 15 mm.

In this partial cross section of a symmetrically constructed pneumatic radial tire, the inner layer 4, consisting of BR rubber, does not run right through the tire interior from bead region 5 to bead region 5, but it is rather the case that the inner layer 4 is omitted within the cross-sectional height 10 of the reinforcing profile. The inner layer 4 consists of two inner layers 4a, 4b not touching one another.

The inner layer 4a in a region lying opposite the tread 1 is arranged between the two upper ends 11 of the reinforcing profiles 9, the inner layer 4a not covering these two ends 11 of the reinforcing profiles 9 axially on the inside, but it rather being the case that the inner layer 4a is led axially outward along the upper ends 11. Consequently, the edge of the inner layer 4a is not exposed, but is arranged between the reinforcing profile 9 and the carcass 3 secured against becoming detached by clamping. The covering 13 of the reinforcing profile 9 by the inner layer 4a takes place contour-parallel over a length of between 5 mm and 15 mm.

In the bead region 5, a further inner-layer strip 4b that runs around the circumference of the tire in a circular ring-shaped manner is arranged at the height of the bead filler 7. The lower end 12 of the reinforcing profile 9 is covered axially on the outside by the inner layer 4b and is arranged clamped securely against becoming detached between the reinforcing profile and the carcass. The covering 14 of these ends 12 takes place contour-parallel over a length of between 5 mm and 15 mm.

### LIST OF REFERENCE SIGNS

### Part of the Description

1 Tread
2 Breaker belt
2a,b Belt ply
3 Carcass
3a Carcass turn-up
4a Inner layer
4b Inner-layer strip
5 Bead region
6 Bead core
7 Bead filler
8 Sidewall
9 Reinforcing profile
10 Cross-sectional height of the reinforcing profile
11 Upper end of the reinforcing profile
12 Lower end of the reinforcing profile
13 Covering
14 Covering
aR Axial direction
rR Radial direction

1.-6. (canceled)

7. A pneumatic vehicle tire having run-flat properties, the pneumatic vehicle tire comprising:
a tread;
a multi-ply breaker belt assembly;
an inner layer of an airtight form;
a carcass comprising a bead region, which in the bead region the carcass is led from axially the inside axially outward around tension-resistant cores as a carcass turn-up; and,
sidewalls, within which there is arranged at least one reinforcing profile which is of a sickle-shaped cross section and is of a continuous ring-shaped form over the circumference of the sidewall;
wherein the inner layer is omitted within a cross-sectional height of the at least one reinforcing profile; and,
wherein the inner layer in a region lying opposite the tread is arranged between upper ends of the at least one reinforcing profiles, and wherein the inner layer does not cover the upper ends of the at least one reinforcing profiles axially on the inside of the at least one reinforcing profiles.

8. The pneumatic vehicle tire as claimed in claim 1, wherein the inner layer is arranged between the two ends of the at least one reinforcing profiles, and wherein the inner layer ends in abutment with the two ends of the at least one reinforcing profiles.

9. The pneumatic vehicle tire as claimed in claim 1, wherein the inner layer is arranged between the two upper ends of the at least one reinforcing profiles, wherein the inner layer is led axially outward along the upper ends of the at least one reinforcing profiles, and wherein the inner layer has a contour-parallel covering of the upper ends of between 5 mm and 15 mm.

10. The pneumatic vehicle tire as claimed in claim 1, wherein the carcass is of a single-ply form and wherein the at least one reinforcing profile is arranged axially on the inside with respect to the carcass.

11. The pneumatic vehicle tire as claimed in claim 1, wherein in the bead region a further inner-layer strip that runs around the circumference of the tire in a circular ring-shaped manner is arranged at the height of a bead filler, wherein the inner-layer strip is led axially outward along a lower end of the at least one reinforcing profiles, and wherein the inner-layer strip has a contour-parallel covering of the lower end of between 5 mm and 15 mm.

12. The pneumatic vehicle tire as claimed in claim 11 further comprising a rubber strip comprising a rubber compound devoid of any butyl rubber compounds, wherein the rubber strip is arranged between the inner layer and the inner-layer strip.

13. The pneumatic vehicle tire as claimed in claim 1, wherein in the bead region a further inner-layer strip that runs around the circumference of the tire in a circular ring-shaped manner is arranged at the height of a bead filler, and wherein the inner-layer strip is led axially inward along a lower end of the at least one reinforcing profiles, and wherein the inner-layer strip has a contour-parallel covering of the lower end of between 5 mm and 15 mm.

14. The pneumatic vehicle tire as claimed in claim 13 further comprising a rubber strip comprising a rubber compound devoid of any butyl rubber compounds, wherein the rubber strip is arranged between the inner layer and the inner-layer strip.
